(19) United States
(12) Patent Application Publication
(10) Pub. No.: US 2008/0224475 A1
(43) Pub. Date: Sep. 18, 2008

(54) Power generation

(76) Inventors: Philip Henry Mellor, Bristol (GB); Julian David Booker, Bristol (GB); Rafal Wrobel, Bristol (GB)

Correspondence Address: JAMES C. WRAY, 1493 CHAIN BRIDGE ROAD, SUITE 300, MCLEAN, VA, 22101, US

(21) Appl. No.: 12/075,125

(22) Filed: Mar. 7, 2008

(30) Foreign Application Priority Data
Mar. 8, 2007 (GB) 07 04 419.1

(51) Int. Cl. F03D 9/00

(52) U.S. Cl. 290/55

(57) ABSTRACT

A generator is configured to generate electrical power from a natural fluid flow, such as wind. The generator has interacting devices for interacting with the fluid flow to generate relative rotation between a first mechanical member (301) and a coaxial second mechanical member (303). The first mechanical member has a plurality of permanent magnets (301) attached thereto so as to define a plurality of magnetic poles. The magnetic poles generate a radial magnetic field that also extends towards the coaxial second member (303). The second member includes a plurality of radially extending teeth (304) that define open slots (305) therebetween. A respective pre-formed coil (306) is located over each alternate tooth such that a single coil winding occupies each of said slots and said coil windings generate an electromotive force during the relative rotation.

### TECHNICAL FIELD

The present invention relates to a generator configured to generate electrical power from a natural fluid flow (such as wind) having interacting devices for interacting with the fluid flow to generate relative rotation between a first mechanical member and a coaxial second mechanical member. In addition, the present invention relates to a method of generating electrical power from wind in which a wind turbine is erected to create relative rotation between a first mechanical member and a coaxial second mechanical member. Furthermore, the present invention also relates to a method of assembling an electrical generator for a wind turbine, such that in operation a first mechanical member rotates relatively to a second coaxial member.

### BACKGROUND OF THE INVENTION

Wind turbines are known, consisting of rotary engines configured to extract energy from the wind. Aerofoils are used to generate lift from the moving wind and to impart this onto a rotor thereby operating as a reaction turbine. In addition, the turbine also gains some energy from the force of the wind, by deflecting the wind at an angle.

A problem with known wind turbine devices is that the speed of rotation is often less than ideal and as such large electrical generating devices may be required or gearing may be required in order to increase the rotational speed.

### BRIEF SUMMARY OF THE INVENTION

According to an aspect of the present invention, there is provided a generator configured to generate electrical power from a natural fluid flow, comprising interacting devices for interacting with the fluid flow to generate relative rotation between a first mechanical member and a coaxial second mechanical member, wherein: said first mechanical member has a plurality of permanent magnets attached thereto so as to define a plurality of magnetic poles; said magnetic poles generate a radial magnetic field that also extends to the coaxial second member; said second mechanical member includes a plurality of radially extending teeth that define open slots therebetween; and a respective preformed coil is located over each of said slots such that a single coil winding occupies each of said slots and said coil windings generate an electromotive force during said relative rotation.

### BRIEF DESCRIPTION OF THE SEVERAL VIEWS OF THE DRAWINGS

FIG. 1 shows a building facility with wind turbines attached thereto;

FIG. 2 shows an electrical generator;

FIG. 3 shows details of the electric generator, including coils;

FIG. 4 shows a cross-section of a coil of the type identified in FIG. 3;

FIG. 5 shows the positioning of coils on a rotational member; and

FIG. 6 shows an exploded view of the electrical generator.

### DESCRIPTION OF THE BEST MODE FOR CARRYING OUT THE INVENTION

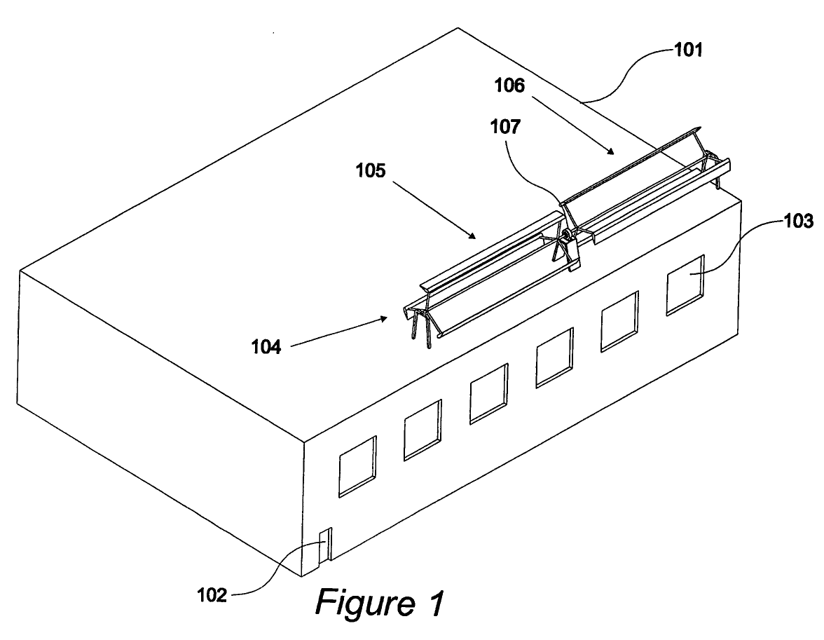

### FIG. 1

A building facility is shown in FIG. 1 that is relatively high and has a flat roof 101. The building includes a doorway 102 of substantially standard size and a plurality of large windows 103. The building includes many electrically powered systems, such as lighting systems, heating/cooling systems and data processing systems etc. Consequently, the activities performed within the building result in a significant consumption of electrical power.

In order to provide a local source of electrical power, electrical generating apparatus 104 has been provided, implemented, in this example, by a first rotating turbine 105, a second rotating turbine 106 and an electrical generator 107.

From the perspective of the power generation apparatus, the wind constitutes a working fluid that contains potential energy (pressure head) and kinetic energy, velocity head. The turbines (105, 106) themselves use aerofoils to generate lift from the moving fluid and to impart this lift upon respective rotors (a form of reaction) in addition to gaining some energy from the impulse of the wind by deflecting it at an angle, hence providing an implementation of an impulse turbine. Impulse turbines change the direction of flow of a high velocity fluid such that the resulting impulse spins the turbine and leaves the fluid with diminished kinetic energy. Reaction turbines develop torque by reacting with the fluid's pressure or weight and the pressure of the fluid changes as it passes through the turbine blades. Thus, engineering techniques are known for extracting energy from wind and for converting it, via rotational mechanisms, into electrical energy for consumption within the building itself or for application to a national grid.

A problem with known electrical generating systems of this type is that the rotational characteristics of the turbines when in operation tend to be less than ideal compared to what would be preferred for most electrical generation systems. In particular, the efficiency and physical size of the electrical generation equipment may be improved if the speed of rotation is increased and this in turn has lead to the development of systems using gear trains for increasing the speed of rotation. This in itself introduces problems in that the overall complexity of the design is increased (resulting in increased costs) and a loss of performance will also occur due to the movement of the gears. Furthermore, in addition to steady state losses, problems may also arise in terms of initiating the rotation of the turbines at relatively low wind speeds.

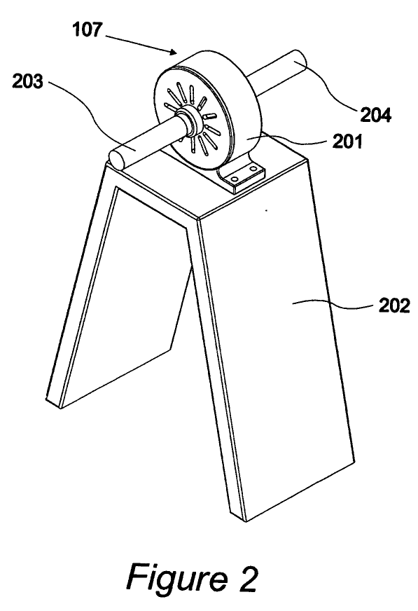

### FIG. 2

Electrical generator 107 is shown in FIG. 2. A generator housing 201 is supported by a support structure 202. A first rotatable shaft 203 is connected to turbine 105 and a second rotatable shaft 204 is connected to turbine 106. In a preferred embodiment turbine 105 is configured to rotate in a first direction (say clockwise) with turbine 106 being configured to rotate in the opposite direction (say counter clockwise). In this way the relative rotational speed of the two shafts 203 and 204 is doubled. Thus, given that the size of an electrical machine will be dictated by its torque capability, this effective doubling of the relative speed of rotation increases the power density by a factor of two.

Thus, as illustrated in FIGS. 1 and 2, a generator is provided that is configured to generate electrical power from a natural fluid flow, such as wind. The generator has interacting devices (turbines) for interacting with the fluid flow to generate relative rotation between a first mechanical member and a coaxial second mechanical member. In this respect, it would be possible for one of the mechanical members to remain stationary, such that one could be referred to as a rotor and the other as a stator. However, in a preferred embodiment, both mechanical members rotate in opposite directions thereby increasing the relative speed of rotation. The rotating mechanical members themselves are retained within housing 201.

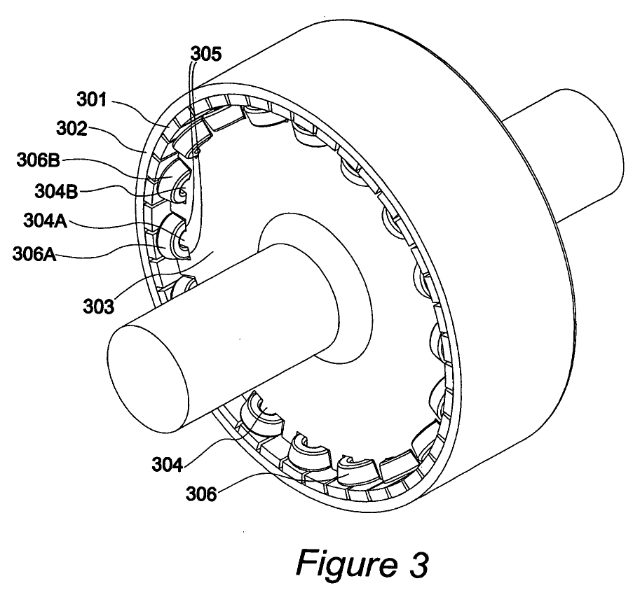

### FIG. 3

Mechanical members contained within housing 201 of FIG. 2 are shown in FIG. 3. The first mechanical member has a plurality of permanent magnets 301. In this example, representing a preferred embodiment, forty-two permanent magnets are provided in the form of standard rectangular blocks that are mounted to a single piece back-iron 302 machined from magnetically permeable steel. The magnets 301 are aligned such that their magnetic poles generate a radial magnetic field that also extends towards the coaxial second member 303. The second mechanical member 303 includes a plurality of radially extending teeth 304 that define open slots 305 therebetween. A respective preformed coil 306 is located over each alternate tooth such that a single coil winding occupies each of said slots and said coil windings generate an electromotive force during the relative rotation. Thus, in the example shown, coil 306A surrounds tooth 304A, while coil 306B surrounds tooth 304B.

The configuration may be considered as an open-slot, external-rotor radial-flux brushless permanent magnet generator, based on a single-layer concentrated modular winding. In this way, it is possible to provide a direct-drive torque-dense electrical machine. The use of an open slot, for the second rotational member, facilitates the manufacturing process, given that coils may be preformed and then inserted over the member's teeth, such as tooth 304A and tooth 304B. The use of permanent magnets also allows the gap between the rotational members to be made larger, typically in the range of 0.8 mm to 1.2 mm and preferably 1.0 mm. This allows tolerances to become more relaxed and again facilitates the manufacturing process. It should be appreciated that larger air gaps may be provided, particularly if this facilitates other operational characteristics, such as ease of assembly.

It can also be appreciated that many options are available in terms of the actual number of magnetic poles and coil slots that are provided for a particular implementation. However, there is a trade-off in terms of providing good torque density with a manageable number of parts, again with a view to mass production. The provision of a relatively large number of poles also relieves problems associated with cogging which for a wind turbine is a genuine issue, given that it is desirable to achieve turbine rotations even at relatively low wind speeds. Again, this must be offset in relation to other problems associated with the provision of a very high pole number, primarily those associated with iron loss and eddy current losses in the permanent magnets. However, it will be appreciated by those skilled in the art that the number of poles and coils present could be increased significantly if a much higher torque generator was required, such as may be appropriate for a much larger turbine. Similarly, fewer poles and coils could be provided for a lower rated machine.

The magnets themselves are fully pitched and diametrically magnetised and formed from a 38MGOe grade of sintered NdFeB. In addition other parameters need to be considered when optimising the design, including the outer diameter of the first rotational member's laminations, the depth of the second member's back iron, the tooth width and the depth of slot. Preferably, the ratio of slots to poles is between 1.0 and 1.5. In the preferred embodiment the number of slots is between thirty and forty, occupied by between fifteen and twenty coils. In the example shown in FIG. 3, eighteen coils occupy thirty-six slots, each coil requiring two slots.

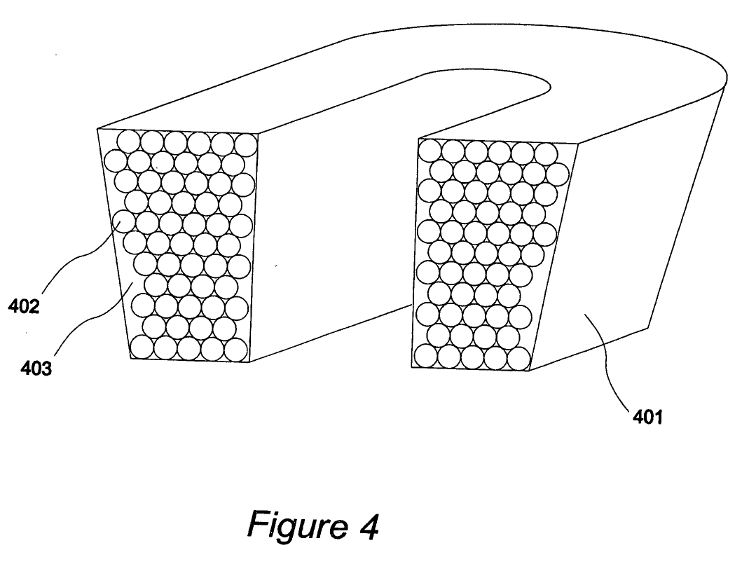

### FIG. 4

A cross-section of an example of a coil is illustrated in FIG. 4. A preformed coil 401 includes typically between ten to twenty coil windings 402. The preformed coils 402 are then secured together by the application of resin 403 within an appropriate die to achieve optimised shape.

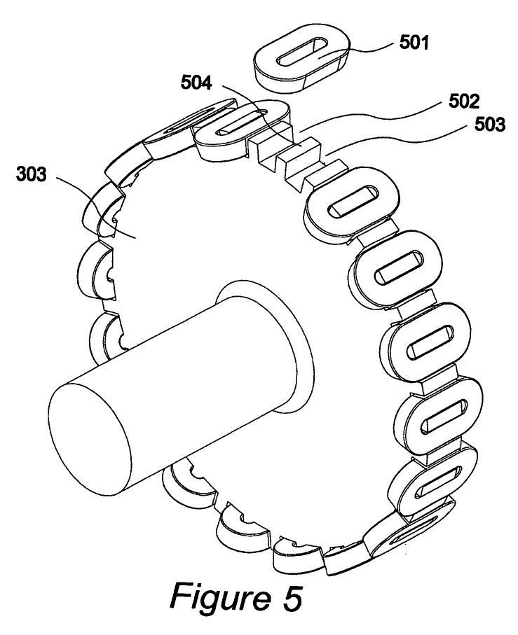

### FIG. 5

A second rotational member 303 is shown in FIG. 5. Preformed coil 501 is about to be received within slots 502 and 503 such that tooth 504 extends within coil 501. Thus, electrically, the coil 501 will effectively be wound around tooth 504. However, to facilitate the assembly process, the coil 501 has been preformed and therefore it becomes relatively straightforward to apply eighteen coils to the second member, as illustrated in FIG. 5.

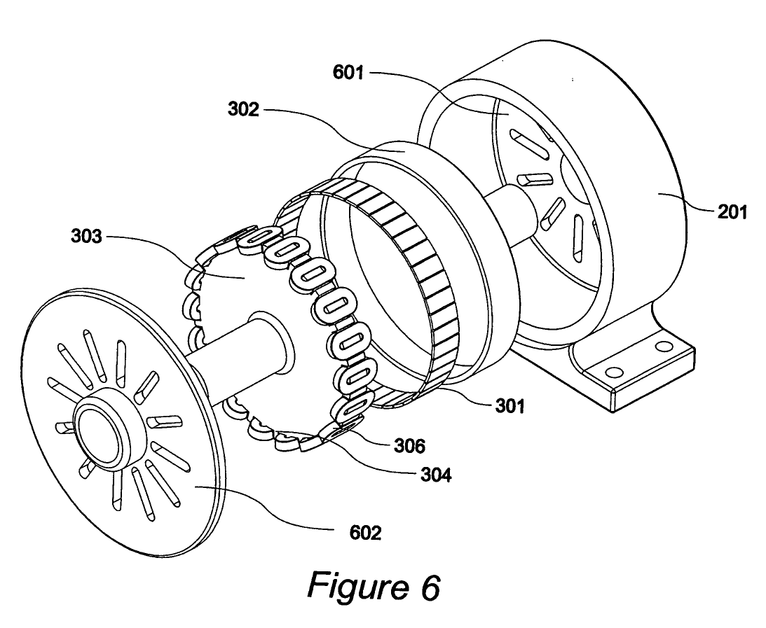

### FIG. 6

An exploded view of the generator elements is shown in FIG. 6. In particular, this illustrates the method of assembly for the electrical generator, having particular application with wind turbines. In operation, a first mechanical member (back-iron 302) rotates relative to a second coaxial mechanical member in the form of rotor 303. A plurality of coils 306 are preformed. Second member (the rotor) 303 includes a plurality of radially extending teeth 304 such that a coil has been located over each alternate one of said teeth.

The first mechanical member 302 has a plurality of permanent magnets 301 attached thereto so as to define a plurality of magnetic poles, wherein the magnetic poles generate a radial magnetic field that also extends towards the coaxial second member.

During fabrication, a substantially cylindrical housing is secured, shown in the embodiment as generator housing 201. A first steel end plate 601 is positioned within housing 201 which then receives the first mechanical member (first rotor) 302, having the permanent magnets 301 attached thereto. Alternatively the end plate 601 could be fabricated in aluminium or formed as part of a casting integral to the housing. The second mechanical member 303, having preformed coils 306 applied thereto, is then inserted within the first mechanical member 302 such that an air gap of the order of 1.0 mm is present between the two magnetically co-operating members. The whole assembly is then secured by a second end plate 602.

1. A generator configured to generate electrical power from a natural fluid flow, comprising interacting devices for interacting with the fluid flow to generate relative rotation between a first mechanical member and a coaxial second mechanical member, wherein:
said first mechanical member has a plurality of permanent magnets attached thereto so as to define a plurality of magnetic poles;
said magnetic poles generate a radial magnetic field that also extends towards the coaxial second member;
said second member includes a plurality of radially extending teeth that define open slots therebetween; and
a respective preformed coil is located over each alternate tooth such that a single coil winding occupies each of said slots and said coil windings generate an electro-motive force during said relative rotation.

2. A generator according to claim 1, wherein said natural fluid flow is created by wind.

3. A generator according to claim 1, wherein said interacting devices are components of a wind turbine.

4. A generator according to claim 3, wherein said components of the wind turbine are contra-rotating, such that the first mechanical member is forced to rotate in a first direction and said second mechanical member is forced to rotate in an opposite direction.

5. A generator according to claim 1, wherein the ratio of slots to poles is between 1.0 and 1.5.

6. A generator according to claim 5, wherein the number of slots is between thirty and forty occupied by between fifteen and twenty coils.

7. A generator according to claim 6, having thirty-six slots, eighteen coils and forty-two poles.

8. A generator according to claim 1, wherein the permanent magnets defining said poles are fully pitched and diametrically magnetised.

9. A generator according to claim 1, wherein each of said coils has between ten and twenty windings per coil.

10. A generator according to claim 1, wherein an air-gap between the magnets and the coils is between 0.8 mm and 1.2 mm.

11. A method of generating electrical power from wind, comprising the steps of:
erecting a wind turbine to create relative rotation between a first mechanical member and a coaxial second mechanical member, wherein:
(a) said first mechanical member has a plurality of permanent magnets attached thereto so as to define a plurality of magnetic poles;
(b) said magnetic poles generate a radial magnetic field that also extends towards the coaxial second member;
(c) said second member includes a plurality of radially extending teeth that define open slots therebetween; and
(d) a respective preformed coil is located over each alternate one of said slots such that a single coil winding occupies each of said slots such that said coil windings generate an electro-motive force during said relative rotation; and
producing an output current in response to the generation of said electro-motive force.

12. A method of generating electrical power from wind according to claim 11, wherein said wind turbine is erected on the roof of a building.

13. A method according to claim 12, wherein the generated electrical power is used for powering devices contained within the building itself.

14. A method according to claim 11, wherein components of the wind turbine are contra-rotating, such that the first mechanical member is forced to rotate in a first direction and the second mechanical member is forced to rotate in an opposite direction.

15. A method of assembling an electrical generator for a wind turbine, such that in operation a first mechanical member rotates relatively to a second coaxial mechanical member, comprising the steps of:
preforming a plurality of coils;
securing a substantially cylindrical housing;
receiving a far end plate within said housing;
receiving said first mechanical member within said housing, said first mechanical member having a plurality of permanent magnets attached thereto so as to define a plurality of magnetic poles, wherein said magnetic poles generate a radial magnetic field that also extends towards the coaxial second member;
receiving said second mechanical member within said housing, said second member including a plurality of radially extending teeth and one of said coils has been located over each alternate tooth, such that a slot is defined between each of said teeth and a single coil winding occupies each of said slots; and
electrically connecting outputs from each of said located coils.

16. A method according to claim 15, wherein the ratio of slots to pole is between 1.0 and 1.5.

17. A method according to claim 16, wherein the number of slots is between thirty and forty; occupied by between fifteen and twenty coils.

18. A method according to claim 17, having thirty-six slots and forty-two poles.

19. A method according to claim 15, wherein the permanent magnets defining said poles are fully pitched and diametrically magnetised.

20. A method according to claim 15, wherein each of said coils has between ten and twenty windings per coil.

21. (canceled)

22. (canceled)
